(19) United States
(12) Patent Application Publication
(10) Pub. No.: US 2026/0002447 A1
(43) Pub. Date: Jan. 1, 2026

(54) STATOR VANE SEGMENT

(71) Applicant: MTU Aero Engines AG, Muenchen (DE)

(72) Inventors: Dennis VON BRAUNECK, München (DE); Franz-Josef ERTL, München (DE); Kaspar WOLF, München (DE)

(21) Appl. No.: 19/318,057

(22) Filed: Sep. 3, 2025

(30) Foreign Application Priority Data
Sep. 6, 2024 (DE) 102024125586.2

(51) Int. Cl. F01D 5/22; F01D 9/04

(52) U.S. Cl. CPC F01D 5/225; F01D 9/041; F05D 2220/323; F05D 2240/12; F05D 2250/75

(57) ABSTRACT

A stator vane segment for a gas turbine, in particular an aircraft engine, including a plurality of stator vanes, a radially outer shroud connecting the plurality of stator vanes, with stiffening elements integral to the shroud or integrated into the shroud being disposed on a radially outer side of the shroud. The stiffening elements form an extension of the stator vanes in the radial direction, and/or that a contour of the stiffening elements on the outer side of the shroud lies within an outer contour formed by a band around a projection of contours of the stator vane at a radially inner side onto the outer side of the shroud, a width of the band in the circumferential direction around the projection relating to no more than 20% of the thickness of the projection.

This claims priority to German Patent Application DE 102024125586.2, filed on Sep. 6, 2024 which is hereby incorporated by reference herein.

The invention relates to a stator vane segment for a compressor of a gas turbine, in particular of an aircraft engine.

### BACKGROUND

Stator vane segments may have reinforcing elements and/or stiffening elements on the outer side of their shroud to absorb or modulate vibrations during operation of the gas turbine and, thus, increase the longevity of the stator vane segment. The stiffening elements may be integrally connected to the shroud. The stator vane segments are usually cast and then further processed.

For example, U.S. Pat. No. 10,876,416 B2 shows a stator vane segment whose shroud has ribs extending along the outer surface thereof. Projections of the chords of the stator vanes intersect the ribs on the shroud. This aims at reducing the dynamic stress induced to the stator vane segment.

### SUMMARY OF THE INVENTION

It is an object of the invention to provide a stator vane segment that can better reduce dynamic stress during operation of the gas turbine.

The present invention provides a stator vane segment for a gas turbine, in particular an aircraft engine, includes a plurality of stator vanes, a radially outer shroud connecting the plurality of stator vanes, with stiffening elements integral to the shroud and/or integrated into the shroud being disposed on the radially outer side of the shroud.

in The present invention provides that the stiffening elements form an extension of the stator vanes in the radial direction, and/or in that a contour of the stiffening elements on the outer side of the shroud lies within an outer contour formed by a band around a projection of contours of the stator vane at a radially inner side onto the outer side of the shroud, a width of the band in the circumferential direction around the projection relating to no more than 20% of the thickness of the projection in the circumferential direction.

Stiffening elements which each form an extension of the stator vane and/or stiffening elements having a contour which, as described, is based on a projection of the stator vanes achieve an even better reduction of the dynamic stress induced to the stator vane segment. This allows, in particular, for optimum damping of vibrations so that, advantageously, component fatigue occurs later than with conventional stator vane segments.

The stator vane segment may preferably be designed for a compressor. Alternatively, the stator vane segment may be designed for a turbine. The stator vane segment may be a segment of a stator vane ring. The stator vane segment and, in particular, the shroud may be curved in the circumferential direction. The shroud may form an outer wall of a flow duct in a casing or intermediate casing of the gas turbine. In a root region, the stator vanes may merge with a fillet into the shroud. The projection of the contours of the stator vane may preferably include the fillet. The band forms an enlarged outer contour around the projection of the stator vane. In other words, it may represent an imaginary enlargement of the projection within which the stiffening element extends on the shroud. The width of the band may also be less than 20%, in particular no more than 10% of the thickness of the projection in the circumferential direction.

The radially inner side of the shroud corresponds to an outer wall of the flow duct. Exactly one stiffening element may be provided for each of the stator vanes.

Further advantages and features of the invention will become apparent from the following description of several preferred exemplary embodiments and from the dependent claims.

In accordance with an advantageous embodiment of the invention, the stiffening elements may be spaced apart in the circumferential direction. This allows the vibration-induced local stresses to be controlled in a particularly advantageous manner.

Another advantageous embodiment of the invention may provide that the stiffening elements are configured as ribs and/or beads. Ribs or beads may be disposed on the outer side of the shroud as narrow ridges or strips. In this way, the stiffness and strength of the shroud can be increased without adding additional weight.

In accordance with a preferred refinement of the invention, a connecting element connecting two adjacent stiffening elements may be disposed between the two adjacent stiffening elements and formed on a radially outer side of the shroud integral to the shroud and/or integrated into the shroud. These additional stiffeners also allow for better damping of shroud bending occurring in the circumferential direction.

In accordance with another preferred refinement of the invention, the stiffening elements and the connecting elements may form a common stiffening structure on the shroud. In particular, all stiffening elements and all connecting elements may form a single common stiffening structure on the shroud. In this way, the shroud is stiffened particularly well with little addition of material.

In accordance with a particularly preferred refinement, the stiffening elements may have a lateral concavity at least along a portion of their longitudinal extent. The concavity may in particular form an undercut. The concavity advantageously makes is possible to avoid additional material and thus weight. The concavity may be a recess formed in the stiffening element and extending in particular in the circumferential direction. The concavity may be located at a lateral surface of the stiffening element extending substantially in the axial direction. The concavity may extend up to a base of the stiffening element. An undercut may be formed in particular in the concavity. The undercut may be configured with respect to the outer lateral surface such that it is not directly accessible and may, in particular, be formed in addition to the concavity in the concavity.

In a specific refinement, it may be provided that the stiffening elements are conical in shape in the radial direction or that the stiffening elements have a T-shaped cross section perpendicular to the axial direction. In particular, one or more of the stiffening elements may have a lateral concavity formed on both sides thereof, when viewed in the circumferential direction, so that in particular a T-shaped structure is obtained. The cross sections of the stiffening elements may be rectangular, partially elliptical, conical, or frusto-conical in shape.

Particularly preferably, the shroud may have a forward, radially outwardly projecting connecting structure in the region of a leading edge of the stator vanes, at least one or all of the stiffening elements beginning in the axial direction at or aft of the connecting structure in an axially forward region of the shroud between 0% and 50% of the axial extent of the shroud. This allows the stator vane segment to be matched to vibration modes in a particularly advantageous manner. The stiffening elements may begin at different points aft of the connecting structure. The connecting structure may serve for connection to a casing of a flow duct in which the stator vanes of the stator vane segment are located. The connecting structure may extend circumferentially along the entire shroud in the region of the leading edges of the stator vanes.

In addition, the shroud may have a rearward, radially outwardly projecting connecting structure in the region of a trailing edge of the stator vanes, and the stiffening structure may end at or on the rearward connecting structure. The rearward connecting structure may extend circumferentially in the region of the trailing edges of the stator vanes, in particular along the entire shroud. The stiffening elements may be disposed between the connecting structures.

Furthermore, in another embodiment, the shroud may have a forward, radially outwardly projecting connecting structure in the region of a leading edge of the stator vanes, and the shroud may have a rearward, radially outwardly projecting connecting structure in the region of a trailing edge of the stator vanes, a groove having a maximum radial groove depth being formed between the forward connecting structure and the rearward connecting structure, and a maximum height of the stiffening elements in the groove as measured from a groove base may be no more than 100%, in particular no more than 50%, preferably 40% of the radial groove depth. The radial groove depth may be measured in particular at the lower of the two connecting structures, particularly preferably at a radially outermost point of the lower connecting structure, adjacent to the groove. This advantageously allows the stator vane segment to be made light in weight and, in addition, ensures that the installation height of the stator vane in the outer region of the engine casing remains low. Furthermore, stiffening elements with small radial heights can already provide a significant improvement of reduction in the dynamic stresses induced to the stator vane segment.

Another aspect of the present invention relates to a compressor for an aircraft engine including a stator vane segment as described above.

Yet another aspect of the present invention relates to an aircraft engine having a compressor as described above and/or having a stator vane segment as described above.

### BRIEF DESCRIPTION OF THE DRAWINGS

The invention will be described in more detail with reference to the following drawings, based on several exemplary embodiments of the invention.

FIG. 1 is a schematic view of an exemplary embodiment of an aircraft engine;

FIG. 2 is a plan view of a stator vane segment according to the invention;

FIG. 3 is a meridional cross-sectional view of the stator vane segment according to the invention;

FIG. 4 is a diagram showing cross sections of possible embodiments of the stiffening elements.

### DETAILED DESCRIPTION

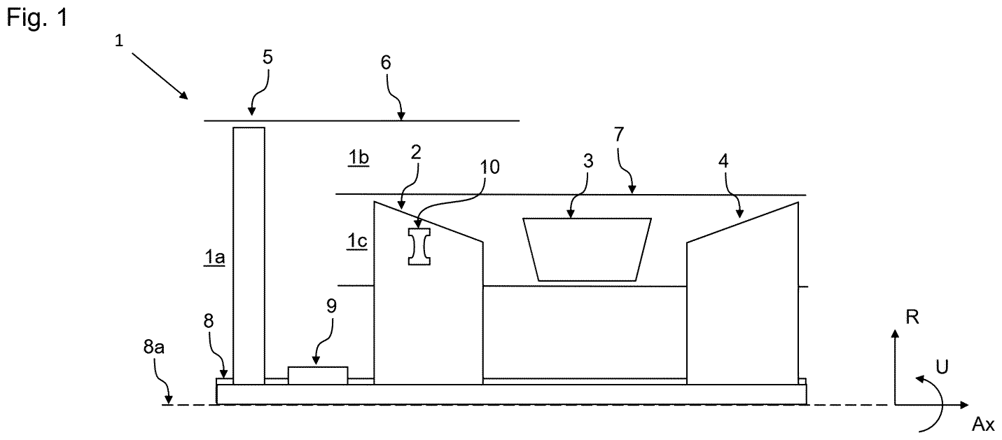

FIG. 1 schematically shows, in meridional cross section, a gas turbine embodied as an aircraft engine 1. Aircraft engine 1 has an engine inlet 1a, from where the flow is delivered downstream to a bypass flow duct 1b and a flow duct 1c serving as a core flow duct 1c. Bypass flow duct 1b serves to generate thrust; core flow duct 1c serves primarily to generate power for the components of aircraft engine 1 and for aircraft cabin systems. The main components of aircraft engine 1, namely a compressor 2, a combustor 3, and a turbine 4, are arranged in flow series in flow duct 1c. Aircraft engine 1 has an engine inlet 1a, the engine outer casing 6 enclosing the entire bypass flow duct 1b, as well as an intermediate casing 7 separating the entire bypass flow duct 1b and flow duct 1c, the intermediate casing 7 serving as the outer casing 7 of flow duct 1c. A fan 5 having one or more fan stages may be disposed in engine inlet 1a for taking in air and subjecting it to a first compression. Fan 5, compressor 2, and turbine 4 are mechanically coupled by at least one shaft 8 rotating about an engine axis of rotation 8a. Fan 5, and possibly also forward low-pressure compressor stages (not shown), may be decoupled by a gearbox 9 from the faster rotating turbine 4, in particular from a low-pressure turbine. Part of the air taken in and compressed by fan 5 flows into flow duct 1c where it is highly compressed by compressor 2 in order to be mixed with fuel and ignited in combustor 3, and finally expanded in turbine 4 for driving the at least one shaft 8.

Engine axis of rotation 8a serves as a reference axis for defining an axial direction Ax extending parallel to engine axis of rotation 8a, a radial direction R perpendicular thereto, and a circumferential direction U extending about engine axis of rotation 8a.

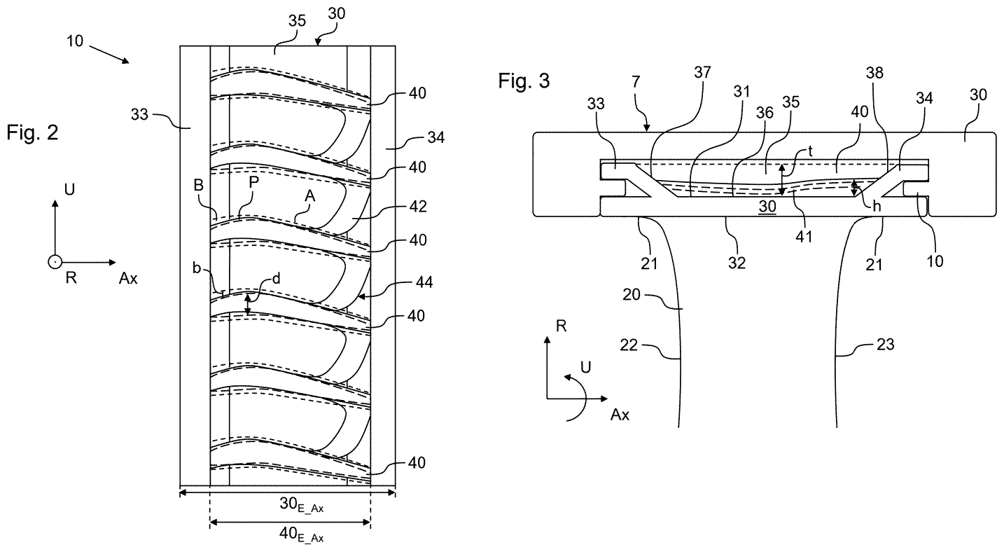

Compressor 2 has an inventive stator vane segment 10, which will be described in more detail below with reference to FIGS. 2 and 3.

FIG. 2 shows the exemplary embodiment of the inventive stator vane segment 10 in a plan view. FIG. 3 shows the exemplary embodiment of the inventive stator vane segment 10 in a sectional view taken along a longitudinal extent of stiffening elements 40 or of stator vanes 20.

In the exemplary embodiment, stator vane segment 10 includes six stator vanes 20, i.e., a plurality of stator vanes 20, disposed adjacent one another in a row in circumferential direction U. A stator vane segment 10 may also include more or fewer stator vanes 20. At their radially outer ends, stator vanes 20 are connected together by a shroud 30 at its radially inner side 32. In the illustration of FIG. 2, stator vanes 20 are hidden from view and their contours 21 obtained on an inner side 32 of shroud 30 are plotted as a projection P on an outer side 31 of shroud 30, shown in FIG. 2. Contours 21 are represented as long-dashed lines.

A forward connecting structure 33 is disposed on outer side 31 of shroud 30 in a region of a leading edge 22 of stator vanes 20, and a rearward connecting structure 34 is disposed on outer side 31 of shroud 30 in a region of a trailing edge 23 of stator vanes 20. Connecting structures 33, 34 serve for connection of stator vane segment 10 to a casing, in particular an intermediate casing 7 of flow duct 1c. Formed between connecting structures 33, 34 is a groove 35 in which are disposed stiffening elements 40 and connecting elements 42 connecting the stiffening elements in circumferential direction U to stiffen shroud 30 and to dampen and thus reduce the dynamic stress induced to the stator vane segment.

In accordance with the invention, stiffening elements 40 may be formed as an extension of stator vanes 20, and/or it may be provided that a contour of stiffening elements 40 on outer side 31 of shroud 30 lies within an outer contour A formed by a band B around the projection P of the contours 21 of stator vane 20 at a radially inner side 32 onto outer side 31 of shroud 30, a width b of band B in circumferential direction U around projection P relating to no more than 20% of thickness d of projection P in circumferential direction U.

Bands B are each represented by short-dashed lines and extend around, or in circumferential direction U in front of and behind, a projected contour 21 of one of the stator vanes 20 on outer side 31 of shroud 30. A band B represents an additional region in or over which portions of stiffening elements 40 may project and/or in which portions of stiffening elements 40 are formed.

Shroud 30 may have an axial extent 30_{E_Ax} in axial direction Ax. Stiffening elements 40 may begin aft of forward connecting structure 33 between 0% and 50% of the axial extent 30_{E_Ax} of the shroud. In other words, stiffening elements 40 may be immediately adjacent the forward connecting structure 33 or spaced therefrom, namely between 0% and 50% of the axial extent of the shroud. Additionally, it may be provided that stiffening elements 40 may begin upstream of rearward connecting structure 34 between 0% and 20% of the axial extent of the shroud. Forward connecting structure 33 may have a slope 37 which descends in axial direction Ax and at or on which a forward end of stiffening element 40 may be disposed. Rearward connecting structure 34 may have a slope 38 which rises in axial direction Ax and at or on which a rear end of stiffening element 40 may be disposed.

Stiffening elements 40 may be spaced apart in circumferential direction U, which reduces the amount of stiffening material that must be provided on shroud 30. A distance between adjacent stiffening elements 40 may correspond to a spacing of adjacent stator vanes 20, or a distance between adjacent stiffening elements 40 may correspond to the spacing of adjacent stator vanes 20, minus no more than a width b of band B. As shown in FIGS. 2 and 3, stiffening elements 40 are configured as ribs, which may in particular extend in a bead-like manner from the region at leading edge 22 of stator vanes 20 to the region at trailing edge 23. The shape of stiffening elements 40 may be determined based on a strength calculation using, for example, a finite-element method or a similar simulation, and may be provided with a free-form cross section, the free form not having to correspond to any geometric primitive, such as a rectangle, a cone, a semicircle, or a partial ellipse, or a combination of these elements. However, it may be provided that stiffening elements 40 are conical in shape in radial direction R or that stiffening elements 40 have a T-shaped cross section perpendicular to axial direction Ax. This cross section may also be a free-form shape. Stiffening elements 40 are integrally connected to shroud 30. In order to manufacture a stiffening element 40, an additive process may be used.

Circumferentially adjacent stiffening elements 40 may be connected by a connecting element 42. A connecting element 42 may be formed, for example, as a rib or bead extending between the two adjacent stiffening elements 40. In the present exemplary embodiment, connecting element 42 has a U-shaped configuration. Connecting element 42 may in particular extend in or quasi in circumferential direction U. In addition, connecting element 42, in particular in a central portion in circumferential direction U, may extend perpendicular or quasi perpendicular to a longitudinal extent of one or both adjacent stiffening element(s) 40. Connecting elements 42 may also have a free-form shape. It may be provided that stiffening elements 40 and connecting elements 42 form a common stiffening structure 44 on shroud 30, in particular that all stiffening elements 40 and all connecting elements 42 form a single common stiffening structure 44 on shroud 30.

As shown in FIG. 3, stiffening element 40 may, for example, have a concavity 41 laterally formed therein which extends from forward to aft. Advantageously, this concavity 41 does not reduce the stiffness of stiffening elements 40 to a significant extent, but makes it possible to use less material for stiffening element 40, which advantageously results in reduced weight. A stiffening element 40 may have the lateral concavity 41 at least along a portion of its longitudinal extent 40_{E_Ax}, and concavity 41 may in particular form an undercut.

Furthermore, as shown in FIG. 3, groove 35 may have a groove depth t, and a maximum height h of stiffening elements 40 in groove 35 as measured from a groove base 36 may be no more than 100%, in particular no more than 50%, preferably 40% of radial groove depth t. Maximum groove depth t may be measured from the radially outermost point of the lower of the two connecting structures 33, 34 to the deepest point of groove base 36.

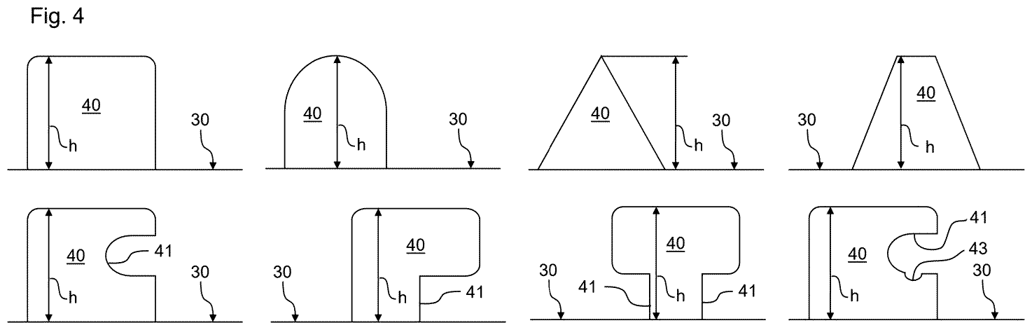

FIG. 4 shows several exemplary cross sections of stiffening elements 40 on shroud 30. Also plotted are the maximum heights h of the respective shapes, the maximum heights each being less than groove depth t shown in FIG. 3.

The upper row shows several basic shapes, which may represent a cross section of stiffening elements 40 in axial direction Ax. From left to right, these are a rectangle, a semiellipse, specifically a semicircle, on a rectangle, a triangle, and a truncated cone. Accordingly, the cross section may be rectangular, partially elliptical, conical, or frusto-conical in shape. The exact dimensions, profiles, and lengths of the sides may differ from these basic shapes and may depend on simulation and calculations.

The lower row shows stiffening elements 40 which have a rectangular basic shape and which have lateral concavities 41. The first illustration shows a stiffening element 40 having a rectangular basic shape and a centrally disposed concavity 41. The second illustration shows a stiffening element 40 having a rectangular basic shape and a concavity 41 extending at the shroud. The third illustration shows a stiffening element 40 which has a rectangular basic shape and concavities 41 extending on both sides, and thus represents an example of a T-shaped cross section. The fourth illustration shows the variant of the first illustration, but with an additional undercut 43 in lateral concavity 41 of stiffening element 40. The exact dimensions, profiles, and lengths of the concavity and the undercut may differ from these basic shapes and may depend on simulation and calculations.

Overall, there is provided a stator vane segment 10 where the dynamic stress induced to the stator vane segment is significantly reduced because of the stiffening elements 40 extending similarly to the stator vanes, and which has an increased service life.

### LIST OF REFERENCE CHARACTERS

1 aircraft engine
1a inlet
1b bypass flow duct
1c core flow duct
2 compressor
3 combustor
4 turbine
5 fan
6 outer casing
7 intermediate casing
8 engine shaft
8a engine axis of rotation
9 gearbox
10 stator vane segment
20 stator vane
21 contour
22 leading edge
23 trailing edge
30 shroud
31 outer side
32 inner side
33 forward connecting structure
34 rearward connecting structure
35 groove
36 groove base
37 descending slope
38 rising slope
40 stiffening element
41 concavity
42 connecting element
43 undercut
44 stiffening structure
B band
B width of the band
A outer contour of the band
P projection of the contours of the stator vane
t groove depth
h height of a stiffening element
Ax axial direction
R radial direction
U circumferential direction

What is claimed is:

1. A stator vane segment for a gas turbine, in particular an aircraft engine, comprising:
a plurality of stator vanes;
a radially outer shroud connecting the plurality of stator vanes;
stiffeners integral to the shroud or integrated into the shroud being disposed on a radially outer side of the shroud,
the stiffeners forming an extension of the stator vanes in the radial direction or
a contour of the stiffeners on the outer side of the shroud lies within an outer contour formed by a band around a projection of contours of the stator vane at a radially inner side onto the outer side of the shroud, a width of the band in the circumferential direction around the projection being no more than 20% of the thickness of the projection in the circumferential direction.

2. The stator vane segment as recited in claim 1 wherein the stiffeners are spaced apart in the circumferential direction.

3. The stator vane segment as recited in claim 1 wherein the stiffeners are configured as ribs or beads.

4. The stator vane segment as recited in claim 1 wherein a connector connecting two adjacent stiffeners is disposed between the two adjacent stiffeners and formed on the radially outer side of the shroud integral to the shroud or integrated into the shroud.

5. The stator vane segment as recited in claim 4 wherein the stiffeners and the connectors form a common stiffening structure on the shroud, in particular in that all stiffeners and all connectors form a single common stiffening structure on the shroud.

6. The stator vane segment as recited in claim 4 wherein all of the stiffeners and all of the connectors form a common stiffening structure on the shroud.

7. The stator vane segment as recited in claim 4 wherein the stiffeners have a lateral concavity at least along a portion of a longitudinal extent.

8. The stator vane segment as recited in claim 7 wherein the concavity forms an undercut.

9. The stator vane segment as recited in claim 1 wherein the stiffeners are conical in shape in the radial direction, or the stiffeners have a T-shaped cross section perpendicular to the axial direction.

10. The stator vane segment as recited in claim 1 wherein the shroud has a forward, radially outwardly projecting connector structure in the region of a leading edge of the stator vanes, and at least one of the stiffeners begins in an axial direction at or aft of the connector structure in an axially forward region of the shroud between 0% and 50% of the axial extent of the shroud.

11. The stator vane segment as recited in claim 10 wherein the shroud has a rearward, radially outwardly projecting connector structure in the region of a trailing edge of the stator vanes, and
the stiffeners end at or on the rearward connector structure.

12. The stator vane segment as recited in claim 1 wherein
the shroud has a forward, radially outwardly projecting connector structure in the region of a leading edge of the stator vanes,
the shroud has a rearward, radially outwardly projecting connector structure in the region of a trailing edge of the stator vanes, and
a groove having a maximum radial groove depth is formed between the forward connector structure and the rearward connector structure, and
wherein a maximum height of the stiffeners in the groove as measured from a groove base is no more than 100%, in particular no more than 50%, preferably 40% of the radial groove depth.

13. The stator vane segment as recited in claim 1 wherein
the shroud has a forward, radially outwardly projecting connector structure in the region of a leading edge of the stator vanes,
the shroud has a rearward, radially outwardly projecting connector structure in the region of a trailing edge of the stator vanes, and
a groove having a maximum radial groove depth is formed between the forward connector structure and the rearward connector structure, and
wherein a maximum height of the stiffeners in the groove as measured from a groove base is no more than 40% of the radial groove depth.

14. The stator vane segment as recited in claim 1 wherein
the shroud has a forward, radially outwardly projecting connector structure in the region of a leading edge of the stator vanes,
the shroud has a rearward, radially outwardly projecting connector structure in the region of a trailing edge of the stator vanes, and
a groove having a maximum radial groove depth is formed between the forward connector structure and the rearward connector structure, and
wherein a maximum height of the stiffeners in the groove as measured from a groove base is no more than 50% of the radial groove depth.

15. A compressor for an aircraft engine comprising the stator vane segment as recited in claim 1.

16. An aircraft engine comprising a stator vane segment
the stator vane segment as recited in claim 1.
